(19) United States
(12) Patent Application Publication
(10) Pub. No.: US 2025/0058510 A1
(43) Pub. Date: Feb. 20, 2025

(54) COMPOSITE MATERIAL AND MANUFACTURING METHOD THEREOF

(71) Applicant: San Fang Chemical Industry Co., Ltd., KAOHSIUNG CITY (TW)

(72) Inventors: CHIH-YI LIN, KAOHSIUNG CITY (TW); KUO-KUANG CHENG, KAOHSIUNG CITY (TW); CHI-CHIN CHIANG, KAOHSIUNG CITY (TW); KUN LIN CHIANG, KAOHSIUNG CITY (TW); DE-YU LI, KAOHSIUNG CITY (TW)

(21) Appl. No.: 18/781,247

(22) Filed: Jul. 23, 2024

(30) Foreign Application Priority Data
Aug. 17, 2023 (TW) 112130912

(51) Int. Cl. B29C 48/21; B29K 101/12; B29L 9/00; B32B 27/08; B32B 27/32; B32B 27/40; B32B 37/15

(52) U.S. Cl. CPC B29C 48/21; B32B 27/08; B32B 27/32; B32B 27/40; B29K 2101/12; B29K 2995/007; B29L 2009/00; B32B 37/153; B32B 2307/536; B32B 2307/718

(57) ABSTRACT

A composite material and a method for manufacturing the composite material are provided. The composite material includes a laminated structure formed by co-extruding a thermoplastic elastomer and a modified thermoplastic elastomer. The use of the thermoplastic elastomer and the modified thermoplastic elastomer in the composite material can significantly reduce emissions during the manufacturing process, and the manufacturing process is simple and stable, and can improve the wear resistance of the composite material.

### BACKGROUND

### 1. Field of the Disclosure

The present disclosure relates to a composite material and a manufacturing method, and to a composite material including a modified thermoplastic elastomer, and a method for manufacturing the composite material.

### 2. Description of the Related Art

As environmental protection requirements increase year on year in countries around the world, regulations on emissions (e.g., volatile organic compounds, carbon emissions, etc.) of many stuff in the manufacturing process are becoming stricter to reduce the pollution caused to the environment. However, it is known that the materials used in the manufacturing of composite materials are not environmentally friendly, and the manufacturing process is complex.

### SUMMARY

In some embodiments, a composite material includes a laminated structure formed by co-extruding a thermoplastic elastomer and a modified thermoplastic elastomer.

In some embodiments, the thermoplastic elastomer includes thermoplastic polyolefin (TPO), thermoplastic rubber (TPR), thermoplastic polyether ester elastomer (TPEE), or thermoplastic polyamide elastomer (TPA), and the modified thermoplastic elastomer includes thermoplastic polyurethane (TPU), a blend of thermoplastic polyolefin (TPO) and maleic anhydride, a blend of thermoplastic polyolefin (TPO) and thermoplastic vulcanizate (TPV), or thermoplastic styrene (TPS).

In some embodiments, a total weight of the modified thermoplastic elastomer is calculated as 100 wt %, and a content of the maleic anhydride is less than or equal to 40 wt %.

In some embodiments, the composite material further includes a substrate layer, wherein the laminated structure is disposed on the substrate layer, and the substrate layer includes non-woven fabric, elastic fabric, woven fabric, ultrafine fabric, thermoplastic elastomer, or modified thermoplastic elastomer.

In some embodiments, the composite material further includes a surface layer adhered to the modified thermoplastic elastomer of the laminated structure, wherein the surface layer includes thermoplastic polyurethane surface layer, water-based polyurethane surface layer, or thermoplastic polyolefin surface layer.

In some embodiments, a method for manufacturing a composite material includes: providing a thermoplastic elastomer raw material and a modified thermoplastic elastomer raw material; and co-extruding the thermoplastic elastomer raw material and the modified thermoplastic elastomer raw material to form a laminated structure.

In some embodiments, a hardness of the thermoplastic elastomer raw material is 50A to 95A, and a hardness of the modified thermoplastic elastomer raw material is 50A to 95A.

In some embodiments, a co-extruding temperature of the thermoplastic elastomer raw material and the modified thermoplastic elastomer raw material is 160° C. to 230° C.

### BRIEF DESCRIPTION OF THE DRAWINGS

Aspects of some embodiments of the present disclosure are readily understood from the following detailed description when read with the accompanying figures. It is noted that various structures may not be drawn to scale, and dimensions of the various structures may be arbitrarily increased or reduced for clarity of discussion.

FIG. 1 illustrates a schematic cross-sectional view of a composite material according to some embodiments of the present disclosure.

FIG. 2 illustrates a schematic cross-sectional view of a composite material according to some embodiments of the present disclosure.

FIG. 3 illustrates a schematic cross-sectional view of a composite material according to some embodiments of the present disclosure.

FIG. 4 illustrates a schematic cross-sectional view of a composite material according to some embodiments of the present disclosure.

FIG. 5 illustrates a schematic cross-sectional view of a composite material according to some embodiments of the present disclosure.

FIG. 6 illustrates a schematic cross-sectional view of a composite material according to some embodiments of the present disclosure.

FIG. 7 illustrates a schematic view of one or more stages of some embodiments of a method for manufacturing a composite material according to the present disclosure.

FIG. 8 illustrates a schematic view of one or more stages of some embodiments of a method for manufacturing a composite material according to the present disclosure.

### DETAILED DESCRIPTION

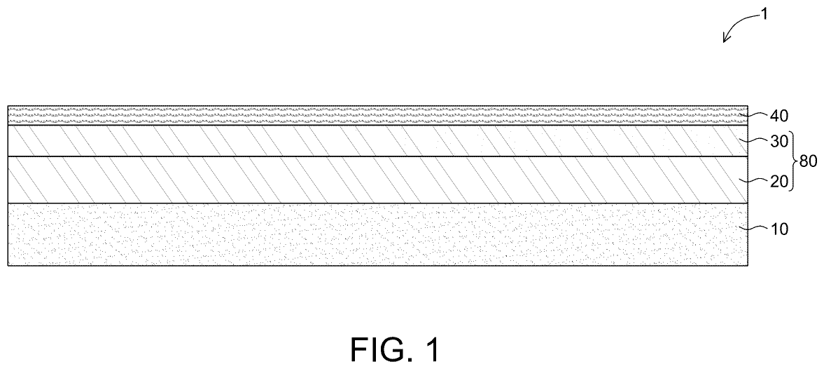

Referring to FIG. 1, which illustrates a schematic cross-sectional view of a composite material 1 according to some embodiments of the present disclosure. The composite material 1 of the present invention includes a substrate layer 10, a laminated structure 80 and a surface layer 40. In some embodiments, the substrate layer 10 may include, but is not limited to, non-woven fabric, elastic fabric, woven fabric, ultrafine fabric, thermoplastic elastomer (TPE), or modified thermoplastic elastomer (m-TPE). In some embodiments, a thickness of the substrate layer 10 may be 0.05 mm to 2.0 mm.

The laminated structure 80 may be disposed on the substrate layer 10. In some embodiments, the laminated structure 80 may be formed by co-extruding a thermoplastic elastomer (TPE) 20 and a modified thermoplastic elastomer (m-TPE) 30. In some embodiments, the thermoplastic elastomer 20 may include, but is not limited to, thermoplastic polyolefin (TPO), thermoplastic rubber (TPR), thermoplastic polyether ester elastomer (TPEE), or thermoplastic polyamide elastomer (TPA). In some embodiments, a thickness of the thermoplastic elastomer 20 may be less than or equal to the thickness of the substrate layer 10. In some embodiments, the thickness of the thermoplastic elastomer 20 may be 0.05 mm to 3.0 mm.

In some embodiments, the modified thermoplastic elastomer 30 may include, but is not limited to, thermoplastic polyurethane (TPU), a blend of thermoplastic polyolefin (TPO) and maleic anhydride, a blend of thermoplastic polyolefin (TPO) and thermoplastic vulcanizate (TPV), or thermoplastic styrene (TPS).

In some embodiments, the purpose of using the blend of thermoplastic polyolefin (TPO) and maleic anhydride is to modify the TPO with the maleic anhydride, enabling an adhesion of the modified thermoplastic elastomer 30 to be greater than an adhesion of the thermoplastic elastomer 20. In some embodiments, a total weight of the modified thermoplastic elastomer 30 is calculated as 100 wt %, and a content of the maleic anhydride may be less than or equal to 40 wt %. When the content of the maleic anhydride is higher than 40 wt %, it will result in the modified thermoplastic elastomer 30 having poor film formation and being non-processable. In some embodiments, the content of the maleic anhydride may be 2 wt % to 38 wt %, 4 wt % to 36 wt %, 6 wt % to 34 wt %, 8 wt % to 32 wt %, 10 wt % to 30 wt %, 12 wt % to 28 wt %, 14 wt % to 26 wt %, 16 wt % to 24 wt %, or 18 wt % to 22 wt %. In some embodiments, a thickness of the modified thermoplastic elastomer 30 may be less than or equal to the thickness of the thermoplastic elastomer 20. In some embodiments, the thickness of the modified thermoplastic elastomer 30 may be 0.05 mm to 3.0 mm.

The surface layer 40 may be adhered to the modified thermoplastic elastomer 30 of the laminated structure 80. In some embodiments, the surface layer 40 may include, but is not limited to, thermoplastic polyurethane surface layer, water-based polyurethane surface layer, or thermoplastic polyolefin surface layer. In some embodiments, the surface layer 40 may have three-dimensional micro-structured textures to increase surface touch, texture, or light and shadow effects. In some embodiments, a heat resistance temperature of the surface layer 40 may be 60° C. to 160° C. In some embodiments, a thickness of the surface layer 40 may be 0.01 mm to 1.0 mm.

In some embodiments, the surface layer 40 may be adhered to the modified thermoplastic elastomer 30 of the laminated structure 80 through an adhesive layer (not shown in the figures). In other words, the adhesive layer is disposed between the surface layer 40 and the modified thermoplastic elastomer 30. In some embodiments, a material of the adhesive layer may include, but is not limited to, thermoplastic polyurethane, water-based polyurethane, or thermoplastic polyolefin.

The composite material 1 of the present invention uses the thermoplastic elastomer 20 and the modified thermoplastic elastomer 30, which can significantly reduce emissions during the manufacturing process, and the manufacturing process is simple and stable, and can improve the wear resistance of the composite material 1.

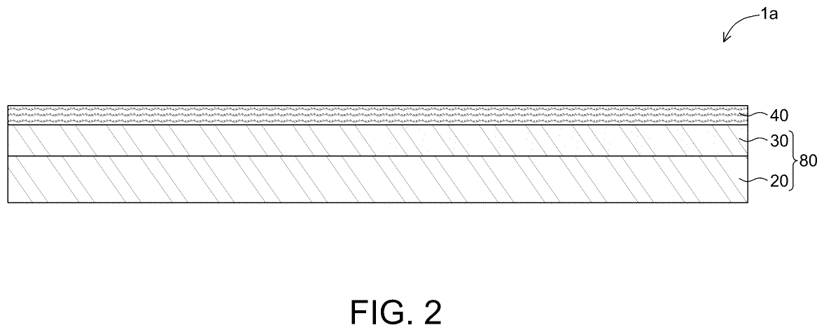

Referring to FIG. 2, which illustrates a schematic cross-sectional view of a composite material 1a according to some embodiments of the present disclosure. The composite material 1a of FIG. 2 has a structure similar to the composite material 1 of FIG. 1, with the only difference being that the composite material 1a of FIG. 2 omits the substrate layer 10 of FIG. 1.

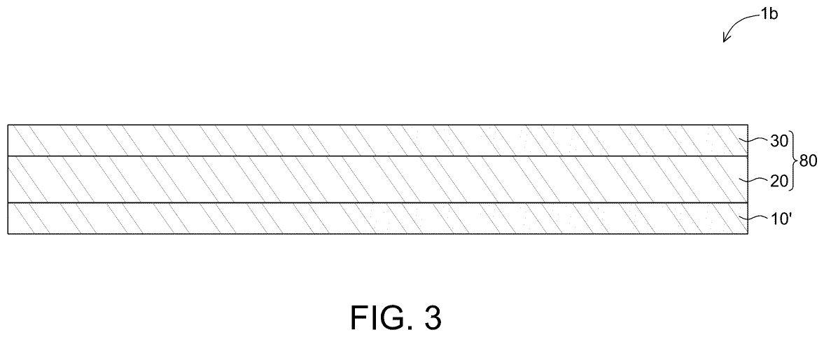

Referring to FIG. 3, which illustrates a schematic cross-sectional view of a composite material 1b according to some embodiments of the present disclosure. The composite material 1b of FIG. 3 has a structure similar to the composite material 1 of FIG. 1, with the only difference being that the composite material 1b of FIG. 3 omits the substrate layer 10 and the surface layer 40 of FIG. 1, and the laminated structure 80 is disposed on a modified thermoplastic elastomer layer 10′.

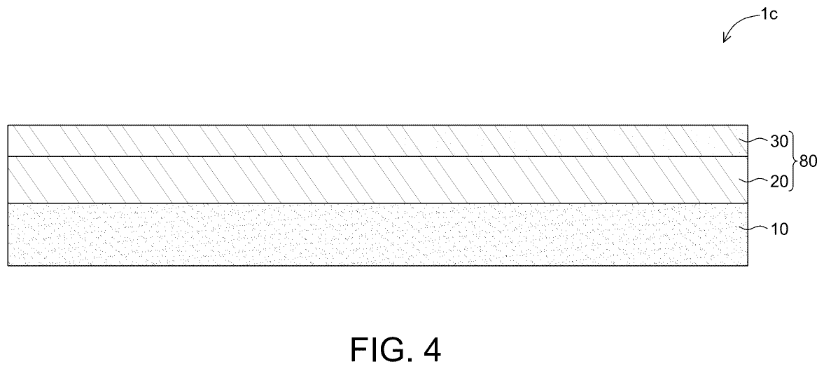

Referring to FIG. 4, which illustrates a schematic cross-sectional view of a composite material 1c according to some embodiments of the present disclosure. The composite material 1c of FIG. 4 has a structure similar to the composite material 1 of FIG. 1, with the only difference being that the composite material 1c of FIG. 4 omits the surface layer 40 of FIG. 1.

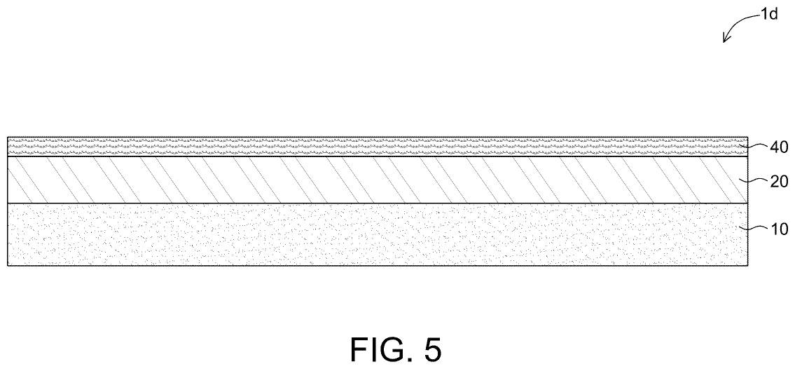

Referring to FIG. 5, which illustrates a schematic cross-sectional view of a composite material 1d according to some embodiments of the present disclosure. The composite material 1d of FIG. 5 has a structure similar to the composite material 1 of FIG. 1, with the only difference being that the composite material 1d of FIG. 5 omits the modified thermoplastic elastomer 30 of FIG. 1.

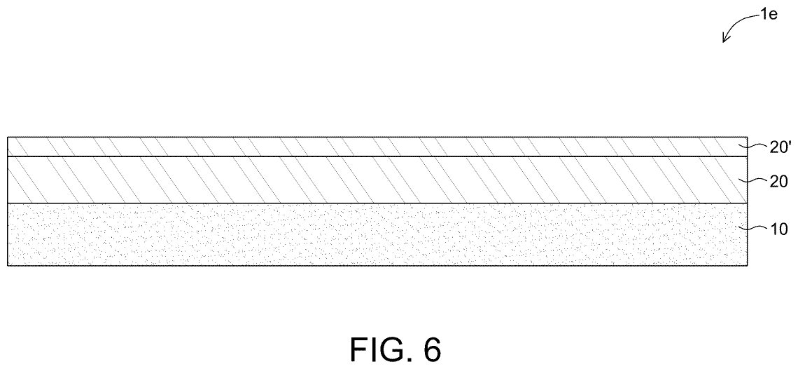

Referring to FIG. 6, which illustrates a schematic cross-sectional view of a composite material 1e according to some embodiments of the present disclosure. The composite material 1e of FIG. 6 has a structure similar to the composite material 1d of FIG. 5, with the only difference being that the composite material 1e of FIG. 6 omits the surface layer 40 of FIG. 5, and a thermoplastic elastomer layer 20′ is disposed on the thermoplastic elastomer 20.

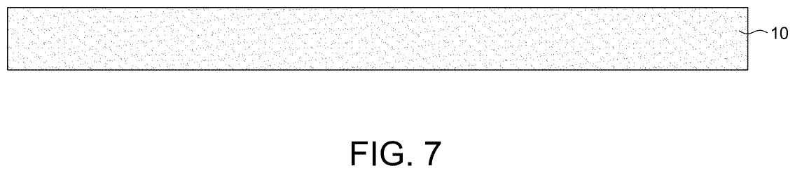

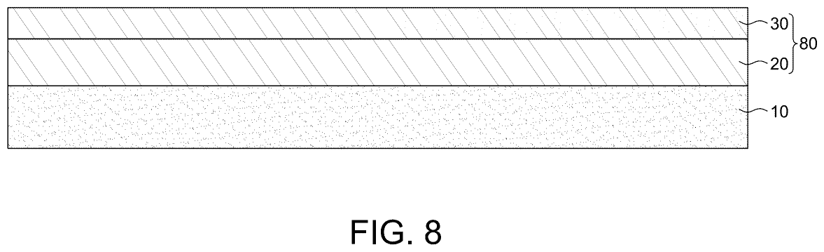

FIG. 7 through FIG. 8 illustrate schematic views of one or more stages of some embodiments of a method for manufacturing a composite material according to the present disclosure. In some embodiments, the method is for manufacturing the composite material 1 as shown in FIG. 1.

Referring to FIG. 7, a substrate layer 10 is provided. The substrate layer 10 of FIG. 7 may be the same as the substrate layer 10 of FIG. 1.

Referring to FIG. 8, a laminated structure 80 is formed on the substrate layer 10. The laminated structure 80 of FIG. 8 may be the same as the laminated structure 80 of FIG. 1. Therefore, the laminated structure 80 of FIG. 8 may include the thermoplastic elastomer 20 of FIG. 1 and the modified thermoplastic elastomer 30 of FIG. 1. In some embodiments, steps of forming the laminated structure 80 may include:

Providing a thermoplastic elastomer raw material and a modified thermoplastic elastomer raw material. In some embodiments, the thermoplastic elastomer raw material may include, but is not limited to, thermoplastic polyolefin (TPO), thermoplastic rubber (TPR), thermoplastic polyether ester elastomer (TPEE), or thermoplastic polyamide elastomer (TPA). The modified thermoplastic elastomer raw material may include, but is not limited to, thermoplastic polyurethane (TPU), a blend of thermoplastic polyolefin (TPO) and maleic anhydride, a blend of thermoplastic polyolefin (TPO) and thermoplastic vulcanizate (TPV), or thermoplastic styrene (TPS). In some embodiments, a hardness of the thermoplastic elastomer raw material may be 50A to 95A, and a hardness of the modified thermoplastic elastomer raw material may be 50A to 95A.

Co-extruding the thermoplastic elastomer raw material and the modified thermoplastic elastomer raw material through a T-shaped co-extrusion die (not shown in the figures) to form the laminated structure 80 (including, for example, the thermoplastic elastomer 20 and the modified thermoplastic elastomer 30). In some embodiments, a co-extruding temperature of the thermoplastic elastomer raw material and the modified thermoplastic elastomer raw material may be 160° C. to 230° C. In some embodiments, the laminated structure 80 (including, for example, the thermoplastic elastomer 20 and the modified thermoplastic elastomer 30) may be formed on the substrate layer 10 by lamination.

Referring to FIG. 1, a surface layer 40 is formed on the modified thermoplastic elastomer 30 of the laminated structure 80 to obtain the composite material 1 as shown in FIG. 1. In some embodiments, the surface layer 40 may include, but is not limited to, thermoplastic polyurethane surface layer, water-based polyurethane surface layer, or thermoplastic polyolefin surface layer. In some embodiments, the surface layer 40 may undergo surface treatment so that the surface layer 40 may have optical haze and a hand feel. In some embodiments, the surface layer 40 may undergo surface creation so that the surface layer 40 may have diverse surfaces. In some embodiments, the surface layer 40 may undergo embossing processes so that the surface layer 40 may have diverse textures.

In the following Table 1, the composite material of Embodiment 1 corresponds to the composite material 1 of FIG. 1, the composite material of Embodiment 2 corresponds to the composite material 1a of FIG. 2, the composite material of Embodiment 3 corresponds to the composite material 1b of FIG. 3, the composite material of Embodiment 4 corresponds to the composite material 1c of FIG. 4, the composite material of Embodiment 5 corresponds to the composite material 1d of FIG. 5, and the composite material of Embodiment 6 corresponds to the composite material 1e of FIG. 6. From the physical property test results in Table 1, it can be found that the wear resistance of Embodiments 1 to 5 composite materials can all reach over 2000 cycles, with the wear resistance of Embodiments 1, 2 and 5 reaching over 3000 cycles. In addition, the current processing temperature requirement for embossing composite materials is about 220° C. to 240° C., while the composite materials of Embodiments 1 to 6 can be surface embossed at 80° C. to 160° C., resulting in reduced overall processing temperature requirements.

TABLE 1
Physical property test results of Embodiments 1-6.

| Physical | Embodiment | Embodiment | Embodiment | Embodiment | Embodiment | Embodiment |
|---|---|---|---|---|---|---|
| property | 1 | 2 | 3 | 4 | 5 | 6 |
| wear | over 3000 | over 3000 | over 2000 | over 2000 | over 3000 | over 1000 |
| resistance | cycles | cycles | cycles | cycles | cycles | cycles |
| weight | 200-500 | 500-700 | 500-700 | 200-500 | 200-500 | 200-500 |
| (g/m²) | | | | | | |
| Embossing | 120-160 | 120-160 | 80-120 | 80-120 | 90-130 | 80-120 |
| temperature | | | | | | |
| (° C.) | | | | | | |
| Hydrolysis | 6-8 weeks | 6-8 weeks | 6-8 weeks | 6-8 weeks | 8-10 weeks | 8-10 weeks |
| (70° C. | | | | | | |
| 95% RH) | | | | | | |

The above embodiments are only for illustrating the principles and effects of the present invention, not for limiting the present invention. Those skilled in the art may make modifications and variations to the above embodiments without departing from the spirit of the present invention. The scope of the present invention should be as set forth in the claims of the patent application.

What is claimed is:

1. A composite material, which includes a laminated structure formed by co-extruding a thermoplastic elastomer and a modified thermoplastic elastomer.

2. The composite material of claim 1, wherein the thermoplastic elastomer includes thermoplastic polyolefin (TPO), thermoplastic rubber (TPR), thermoplastic polyether ester elastomer (TPEE), or thermoplastic polyamide elastomer (TPA), and the modified thermoplastic elastomer includes thermoplastic polyurethane (TPU), a blend of thermoplastic polyolefin (TPO) and maleic anhydride, a blend of thermoplastic polyolefin (TPO) and thermoplastic vulcanizate (TPV), or thermoplastic styrene (TPS).

3. The composite material of claim 2, wherein a total weight of the modified thermoplastic elastomer is calculated as 100 wt %, and a content of the maleic anhydride is less than or equal to 40 wt %.

4. The composite material of claim 1, further comprising a substrate layer, wherein the laminated structure is disposed on the substrate layer, and the substrate layer includes non-woven fabric, elastic fabric, woven fabric, ultrafine fabric, thermoplastic elastomer, or modified thermoplastic elastomer.

5. The composite material of claim 1, further comprising a surface layer adhered to the modified thermoplastic elastomer of the laminated structure, wherein the surface layer includes thermoplastic polyurethane surface layer, water-based polyurethane surface layer, or thermoplastic polyolefin surface layer.

6. A method for manufacturing a composite material, comprising:
providing a thermoplastic elastomer raw material and a modified thermoplastic elastomer raw material; and
co-extruding the thermoplastic elastomer raw material and the modified thermoplastic elastomer raw material to form a laminated structure.

7. The method of claim 6, wherein the thermoplastic elastomer raw material includes thermoplastic polyolefin (TPO), thermoplastic rubber (TPR), thermoplastic polyether ester elastomer (TPEE), or thermoplastic polyamide elastomer (TPA), and the modified thermoplastic elastomer raw material includes thermoplastic polyurethane (TPU), a blend of thermoplastic polyolefin (TPO) and maleic anhydride, a blend of thermoplastic polyolefin (TPO) and thermoplastic vulcanizate (TPV), or thermoplastic styrene (TPS).

8. The method of claim 6, wherein a hardness of the thermoplastic elastomer raw material is 50A to 95A, and a hardness of the modified thermoplastic elastomer raw material is 50A to 95A.

9. The method of claim 6, wherein a co-extruding temperature of the thermoplastic elastomer raw material and the modified thermoplastic elastomer raw material is 160° C. to 230° C.
